(19) United States
(12) Patent Application Publication
(10) Pub. No.: US 2015/0206632 A1
(43) Pub. Date: Jul. 23, 2015

(54) SOFT MAGNETIC IRON-COBALT-BASED ALLOY AND METHOD FOR THE PRODUCTION OF A SOFT MAGNETIC IRON-COBALT-BASED ALLOY

(71) Applicant: VACUUMSCHMELZE GMBH & CO. KG, Hanau (DE)

(72) Inventors: Jan Frederik FOHR, Ransbach-Baumbach (DE); Niklas VOLBERS, Bruchkobel (DE)

(73) Assignee: VACUUMSCHMELZE GMBH & CO. KG, Hanau (DE)

(21) Appl. No.: 14/600,160

(22) Filed: Jan. 20, 2015

(30) Foreign Application Priority Data
Jan. 20, 2014 (DE) 10 2014 100 589.9

(51) Int. Cl. H01F 1/147; C22C 38/50; C22C 38/48; C22C 38/46; C22C 38/00; C22C 38/42; C22C 38/06; C22C 38/04; C22C 38/02; C22C 38/52; C22C 38/44

(52) U.S. Cl. CPC H01F 1/147; C22C 38/52; C22C 38/50; C22C 38/48; C22C 38/46; C22C 38/44; C22C 38/42; C22C 38/06; C22C 38/04; C22C 38/02; C22C 38/005; C22C 38/004; C22C 38/001

(57) ABSTRACT

Soft magnetic iron-cobalt-based alloys and a method for producing semi-finished products from these alloys are disclosed. The alloys may have a composition consisting essentially of
20% by weight≦Co≦30% by weight,
0% by weight≦Cr≦0.25% by weight,
0.06% by weight≦(2*Nb+Ta)≦0.8% by weight,
0.01% by weight≦Mn≦0.5% by weight,
0% by weight≦Si≦0.5% by weight,
0% by weight≦Ca≦0.01% by weight,
0% by weight≦Mg≦0.01% by weight,
0% by weight≦Ce≦0.01% by weight,
0% by weight≦Ni≦1.0% by weight, 0% by weight≦Al≦1.0% by weight,
0% by weight≦V≦1.0% by weight, 0% by weight≦Mo≦1.0% by weight,
0% by weight≦Zr≦0.1% by weight, 0% by weight≦Ti≦0.1% by weight,
0% by weight≦Cu≦0.1% by weight, 0% by weight≦W≦0.1% by weight,
0% by weight≦S≦0.01% by weight, 0% by weight≦O≦0.02% by weight,
0% by weight≦N≦0.01% by weight, 0% by weight≦C≦0.01% by weight,
0% by weight≦P≦0.01% by weight, 0% by weight≦B≦0.01% by weight,
remainder iron.

This application claims benefit of German Patent Application No. DE 10 2014 100 589.9, filed 20 Jan. 2014, the entire contents of which is incorporated herein by reference for all purposes.

### BACKGROUND

1. Field

The application relates to a soft magnetic iron-cobalt-based alloy and to a method for the production of semi-finished products from this alloy, in particular of magnetic components for magnetic flux guidance elements. Such alloys have a high saturation polarisation J_{S} and can therefore be used for forming electromagnetic systems having high forces and/or a small overall volume. Typical applications for these alloys are magnetic actuators, magnetic lenses, core material for solenoids, transformers, magnetic screening devices, rotating electric machines, relays and magnetic bearings.

2. Description of Related Art

U.S. Pat. No. 4,933,026 and U.S. Pat. No. 5,501,747 disclose alloys which contain 49% by weight of cobalt and 49% by weight of iron, with an addition of vanadium and/or niobium and/or tantalum. Owing to their cobalt content, these soft magnetic iron-cobalt-based alloys are generally characterised by a very high saturation polarisation J_{S}, which is considerably higher than that of pure iron or steel.

However, semi-finished products and parts for soft magnetic components with a high power density do not only require good soft magnetic properties, in particular a high magnetic saturation polarisation J_{S} and a very low coercitive field strength, but as a rule a high elongation at fracture A_{L} and ductility as well.

In the following description, the term “elongation at fracture A_{L}” is to be understood as the length change at break relative to the starting length of a test bar. The length change is determined on the torn test bar.

The magnetic polarisation J is the part of the magnetic flux density which is induced in the magnetised material. The polarisation is the magnetisation M multiplied by the vacuum permeability. The saturation polarisation J_{S} is the highest obtainable magnetic polarisation J in a magnetic material at a given temperature.

In spite of their excellent soft magnetic properties, these alloys, which contain approximately the same amounts of cobalt and iron and possibly one or more additions of vanadium and/or niobium and/or tantalum, are after an annealing process present in an almost completely ordered state and are therefore relatively brittle at room temperature, i.e. they do not have a high elongation at fracture A_{L} and ductility.

U.S. Pat. No. 5,741,374 discloses an alloy in which the cobalt content has been greatly reduced relative to the iron content with the composition 27.0% by weight of cobalt, 0.60% by weight of nickel, 0.25% by weight of silicon, 0.25% by weight of manganese, 0.60% by weight of chromium, 0.01% by weight of carbon, remainder iron. This alloy has been commercially available for a long time under the name HIPERCO™ 27. Although this alloy has a comparatively high elongation at fracture A_{L} and ductility, its magnetic saturation polarisation J_{S} is considerably lower than in the alloys with a high cobalt content disclosed in U.S. Pat. No. 4,933,026 and U.S. Pat. No. 5,501,747.

An iron-cobalt-based alloy range which offers not only a very high elongation at fracture A_{L} and ductility in the hot-formed state, but also an excellent magnetic saturation polarisation J_{S} in the annealed state at room temperature would be desirable.

### SUMMARY

A soft magnetic alloy is provided which consists essentially of:

20% by weight≦Co≦30% by weight,

0% by weight≦Cr≦0.25% by weight,

0.06% by weight≦(2*Nb+Ta)≦0.8% by weight,

0.01% by weight≦Mn≦0.5% by weight,

0% by weight≦Si≦0.5% by weight,

0% by weight≦Ca≦0.01% by weight,

0% by weight≦Mg≦0.01% by weight,

0% by weight≦Ce≦0.01% by weight,

0% by weight≦Ni≦1.0% by weight, 0% by weight≦Al≦1.0% by weight,

0% by weight≦V≦1.0% by weight, 0% by weight≦Mo≦1.0% by weight,

0% by weight≦Zr≦0.1% by weight, 0% by weight≦Ti≦0.1% by weight,

0% by weight≦Cu≦0.1% by weight, 0% by weight≦W≦0.1% by weight,

0% by weight≦S≦0.01% by weight, 0% by weight≦O≦0.02% by weight,

0% by weight≦N≦0.01% by weight, 0% by weight≦C≦0.01% by weight,

0% by weight≦P≦0.01% by weight, 0% by weight≦B≦0.01% by weight, remainder iron.

This iron-based alloy therefore includes Co, Nb and/or Ta and Mn and virtually no carbon, with a maximum up to 0.01% by weight. This maximum carbon content should be considered as an unavoidable impurity. It is recognised that carbon contents above 0.01% by weight not only result in a noticeable worsening of elongation at fracture A_{L} and ductility owing to the formation of carbides, but also in a worsening of magnetic properties.

The alloy includes niobium and/or tantalum which are thought to bring about a good grain refining action in the carbon-free structure, resulting in an excellent elongation at fracture A_{L} and a high ductility. An alloy with an elongation at fracture A_{L} of greater or equal to 25% is defined herein as ductile. An alloy with a values of elongation at fracture A_{L} of less than 5% is defined herein as brittle.

For obtaining very good magnetic properties and at the same time very good mechanical properties, niobium and/or tantalum contents of 0.150% by weight (2*Nb +Ta)≦0.350% by weight, 0.250% by weight≦(2*Nb+Ta)≦0.350% by weight and 0.280% by weight≦(2*Nb+Ta)≦0.320% by weight have been found to be useful.

In view of the raw material costs of tantalum, which are considerably higher than those of niobium, in some alloys, the alloy is tantalum-free, which means a maximum tantalum content of 0.02% by weight. This maximum tantalum content should be considered as an unavoidable impurity in the niobium used. In the present alloys, tantalum and niobium are deemed to act in a homologous manner in the structure.

In tantalum-free alloys, niobium contents of 0.10% by weight≦Nb≦0.20% by weight, 0.120% by weight≦Nb≦0.18%, 0.130% by weight≦Nb≦0.170% by weight and 0.140% by weight≦Nb≦0.160% by weight may be used.

The alloy may include silicon and have a silicon content of 0.01% by weight≦Si≦0.50% by weight. The manganese content may be restricted to 0.01% by weight≦Mn≦0.2% by weight.

The manganese and silicon contents may be 0.01% by weight≦Mn≦0.2% by weight and 0.01% by weight≦Si≦0.2% by weight, or 0.04% by weight≦Mn≦0.12% by weight and 0.04% by weight≦Si≦0.12% by weight.

The alloys may have a cobalt content of 20% by weight≦Co≦28% by weight; particularly preferred is a cobalt content of 25% by weight≦Co≦28% by weight. These cobalt contents have been found to be particularly useful in obtaining a high saturation polarisation J_{S} accompanied by a high elongation at fracture A_{L}.

### DETAILED DESCRIPTION OF SPECIFIC EMBODIMENTS

In an embodiment, the soft magnetic alloy consists essentially of 26.4% by weight≦Co≦27.6% by weight, 0% by weight≦Cr≦0.1% by weight, 0.120% by weight≦Nb≦0.18% by weight and Ta=0% by weight, 0.04% by weight≦Mn≦0.12% by weight, and 0.04% by weight≦Si≦0.12% by weight, 0% by weight≦S≦0.01% by weight, 0% by weight≦O≦0.02% by weight, 0% by weight≦N≦0.01% by weight, 0% by weight≦C≦0.01% by weight, 0% by weight≦P≦0.01% by weight, 0% by weight≦B≦0.01% by weight, remainder iron.

The alloys may be free of chromium and molybdenum. In some alloys, these elements are added to the alloy in order to improve its mechanical properties. As a rule, however, these elements result in a worsening of magnetic properties.

In the alloys, manganese and/or silicon is/are added to the alloy only in small quantities for deoxidation and sulphur removal. For a particularly effective deoxidation and sulphur removal, up to 0.01% by weight of Cer or a Cer metal mixture can be added to the alloy. Additions of up to 0.01% by weight of calcium and/or magnesium can also be used for the same purpose.

The alloy can moreover be free of aluminium and/or nickel. Up to 1.00% by weight of nickel and/or up to 0.2% by weight or 0.02% by weight of Al can be added, however.

The alloys described herein may be fabricated by initially melting in a vacuum induction furnace. They can, however, also be processed by vacuum-arc melting or electroslag refining. The alloy is first cast to form an ingot, freed of any present oxide film and then and then conventionally hot formed, for example forged or rolled at temperatures between 900° C. and 1300° C. A thermomechanical processing is also possible to improve the mechanical properties of the semi-finished product. As an alternative, the oxide film can be removed from previously forged or rolled bar material. The desired dimensions can be obtained hot-working strip, billet or bar material. As an alternative, the desired final dimensions can be obtained by cold-forming strip, bar or wire material.

If the material is excessively hardened following a cold-forming process, one or more intermediate annealing processes can be performed at temperatures between 400° C. and 1000° C. for recovery and crystallisation.

Optionally, a magnetic final annealing process can be performed at temperatures between 700° C. and 1000° C. as a last processing step. Following such a magnetic final annealing process, the alloy is then cooled down from annealing temperature at a rate of 50° C. to 800° C. per hour, preferably at a rate of 100° C. to 200° C. per hour.

In the hot-worked state, the alloy may have an elongation at fracture A_{L}≧30% or A_{L}≧25% and a polarisation J≧2.35 Tesla in the annealed state at room temperatures and under the application of a field strength of 400 A/cm and, therefore, have the combination of good mechanical properties, in particular ductility, and good magnetic properties, in particular a polarisation J₄₀₀ of at least 2.35 Tesla.

To illustrate the unique combination of very good mechanical properties and very good magnetic properties offered by the alloys, the alloys listed in Tables 1 to 3 were produced and investigated. The alloys designated with batch numbers 9273, 9274, 9275, 9276, 9277, 9278, 9279, 9280 and 9530 are not part of the claimed invention. Owing to their high carbon content, batch numbers 9528 and 9529 are not within the scope of the claimed invention. The alloys designated with batch numbers 9697 and 9698 are also not within the scope of the claimed invention as they are free of Nb and Ta.

For comparison purposes, the niobium- and tantalum-free alloys listed in Tables 4 to 6 were produced and likewise tested for their mechanical and magnetic properties. The alloys listed in Tables 4 to 6 with the batch numbers 9274 and 9278 to 9281 are included for comparison only and are not within the scope of the claimed invention.

Properties were tested using material fabricated from 5 kg ingots. The alloys were melted in a vacuum and then cast into a circular mould at approximately 1500° C.

After the removal of the oxide film from the individual ingots, the ingots were hot-rolled at temperatures between approximately 1000° C. and 1300° C. to produce 12 mm bars. The resulting hot-rolled bars were then turned to a diameter of approximately 10 mm, followed by a cutting to a length of approximately 120 mm.

The magnetic and mechanical properties were then measured both in the non-annealed and in the annealed state at room temperature.

Table 1 summarises the mechanical properties measured for the alloys. To characterise the mechanical properties, the strength of the test bars was measured, using the module of elasticity E, the yield strength R_{p0.2}, the tensile strength Rₘ, the elongation at fracture A_{L} and the Vickers hardness HV10, both in the annealed and in the non-annealed state at room temperature. The yield strength R_{p0.2} is the limit value at which a defined plastic deformation of 0.2% occurs. The elongation at fracture A_{L} was determined on tensile specimens with a measuring length of 50 mm.

Table 2 summarises the magnetic properties of the alloys. To characterise the magnetic properties, the electric resistance rho, the maximum permeability μₘₐₓ, the coercitive field strength H_{C} and the polarisation J at field strengths of 100, 160, 200 and 400 A/cm were measured on the test bars both in the annealed and in the non-annealed state at room temperature.

Table 3 summarises the measured composition of the alloys. The analysis of the chemical composition of the alloys was based on X-ray fluorescence analyses. The precise carbon, sulphur, oxygen and nitrogen contents were analysed using a hot gas extraction. Values given in Table 3 as less than 0.01 weight percent indicate a value less than the detection limit.

Compared to the alloys according to the claimed invention, the comparative alloys of Tables 4 to 6 exhibited either similar mechanical properties, but significantly worse magnetic properties or similar magnetic properties, but significantly worse mechanical properties.

The detrimental influence of carbon in combination with niobium is reflected in the reduction of the elongation at fracture A_{L} in the batch numbers 9528 and 9529 in Tables 1 to 3.

Alloys can be produced which have an elongation at fracture A_{L}≧25% or A_{L}≧30% in the hot-worked state and a polarisation J≧2.35 Tesla in the annealed state at room temperatures and under the application of a field strength of 400 A/cm.

TABLE 1
Mechanical Properties

| Batch | Co | Additions | Annealed | E in GPa | Rp_{0.2} in MPa | Rm in MPa | A_{L} in % | HV10 |
|---|---|---|---|---|---|---|---|---|
| 9522 | 27 | 0.1 Nb | 10 h 850° C. | 213 | 217 | 460 | 5.10 | 158 |
| 9522 | 27 | 0.1 Nb | non-ann. | 212 | 406 | 560 | 29.60 | 219 |
| 9523 | 27 | 0.3 Nb | 10 h 850° C. | 215 | 248 | 554 | 30.90 | 173 |
| 9523 | 27 | 0.3 Nb | non-ann. | 220 | 418 | 579 | 25.70 | 215 |
| 9524 | 27 | 0.4 Nb | 10 h 850° C. | 220 | 291 | 591 | 24.50 | 190 |
| 9524 | 27 | 0.4 Nb | non-ann. | 225 | 479 | 624 | 19.60 | 239 |
| 9525 | 27 | 0.4 Ta | 10 h 850° C. | 218 | 237 | 545 | 32.70 | 167 |
| 9525 | 27 | 0.4 Ta | non-ann. | 225 | 479 | 594 | 23.80 | 233 |
| 9526 | 27 | 0.15 Nb 0.1 Ta | 10 h 850° C. | 234 | 245 | 554 | 31.00 | 180 |
| 9526 | 27 | 0.15 Nb 0.1 Ta | non-ann. | 230 | 506 | 616 | 21.40 | 225 |
| 9527 | 27 | 0.15 Nb 0.01 C | 10 h 850° C. | 208 | 252 | 545 | 28.60 | 180 |
| 9527 | 27 | 0.15 Nb 0.01 C | non-ann. | 228 | 418 | 575 | 26.80 | 213 |
| 9528 | 27 | 0.15 Nb 0.05 C | 10 h 850° C. | 219 | 425 | 627 | 23.10 | 198 |
| 9528 | 27 | 0.15 Nb 0.05 C | non-ann. | 215 | 512 | 608 | 3.70 | 230 |
| 9529 | 27 | 0.15 Nb 0.1 C | 10 h 850° C. | 219 | 279 | 544 | 17.60 | 172 |
| 9529 | 27 | 0.15 Nb 0.1 C | non-ann. | 248 | 537 | 654 | 3.80 | 260 |
| 9530 | 27 | 0.15 Nb 1 Cr | 10 h 850° C. | 216 | 250 | 554 | 35.80 | 172 |
| 9530 | 27 | 0.15 Nb 1 Cr | non-ann. | 236 | 440 | 600 | 24.30 | 246 |
| 9531 | 27 | 0.15 Nb 0.1 Mn 0.1 Si | 10 h 850° C. | 224 | 255 | 559 | 31.90 | 172 |
| 9531 | 27 | 0.15 Nb 0.1 Mn 0.1 Si | non-ann. | 238 | 385 | 571 | 28.60 | 223 |
| 9697 | 22 | — | 10 h 850° C. | 198 | — | 213 | 0.01 | 138 |
| 9697 | 22 | — | non-ann. | 179 | 245 | 432 | 37.80 | 144 |
| 9697 | 22 | — | 10 h 850° C. | 218 | — | 237 | 0.04 | 138 |
| 9697 | 22 | — | non-ann. | 175 | 246 | 396 | 6.23 | 149 |
| 9698 | 30 | — | 10 h 850° C. | 211 | — | 269 | 0.00 | 185 |
| 9698 | 30 | — | non-ann. | 217 | 322 | 343 | 0.81 | 184 |
| 9698 | 30 | — | 10 h 850° C. | 231 | — | 303 | 0.09 | 187 |
| 9698 | 30 | — | non-ann. | 216 | 318 | 324 | 0.61 | 185 |
| 9699 | 22 | 0.15Nb | 10 h 850° C. | 227 | 180 | 427 | 41.64 | 137 |
| 9699 | 22 | 0.15Nb | non-ann. | 195 | 311 | 458 | 34.96 | 152 |
| 9699 | 22 | 0.15Nb | 10 h 850° C. | 224 | 184 | 429 | 43.25 | 142 |
| 9699 | 22 | 0.15Nb | non-ann. | 183 | 306 | 457 | 36.53 | 147 |
| 9700 | 30 | 0.15Nb | 10 h 850° C. | 252 | 233 | 493 | 5.35 | 171 |
| 9700 | 30 | 0.15Nb | non-ann. | 209 | 324 | 505 | 3.61 | 183 |
| 9700 | 30 | 0.15Nb | 10 h 850° C. | 235 | 236 | 526 | 6.06 | 172 |
| 9700 | 30 | 0.15Nb | non-ann. | 182 | 343 | 598 | 32.39 | 186 |
| 9282 | 27 | 0.15 Nb | 10 h 850° C. | 190 | 220 | 531 | 17.50 | 156 |
| 9282 | 27 | 0.15 Nb | non-ann. | 224 | 344 | 529 | 33.00 | 184 |

TABLE 2
Magnetic Properties

| Batch | Co | Additions | Annealed | J100 | J160 | J200 | J400 | μmax | H_{C} in A/cm | rho |
|---|---|---|---|---|---|---|---|---|---|---|
| 9522 | 27 | 0.1 Nb | 10 h 850° C. | 2.127 | 2.232 | 2.282 | 2.383 | 2686 | 1.379 | 0.1308 |
| 9522 | 27 | 0.1 Nb | non-ann. | | | | | | 4.697 | |
| 9523 | 27 | 0.3 Nb | 10 h 850° C. | 2.130 | 2.238 | 2.288 | 2.389 | 2420 | 1.603 | 0.1403 |
| 9523 | 27 | 0.3 Nb | non-ann. | | | | | | 4.034 | |
| 9524 | 27 | 0.4 Nb | 10 h 850° C. | 2.112 | 2.219 | 2.268 | 2.363 | 1672 | 2.700 | 0.1347 |
| 9524 | 27 | 0.4 Nb | non-ann. | | | | | | 5.697 | |
| 9525 | 27 | 0.4 Ta | 10 h 850° C. | 2.138 | 2.243 | 2.295 | 2.393 | 2875 | 1.337 | 0.1342 |
| 9525 | 27 | 0.4 Ta | non-ann. | | | | | | 4.690 | |
| 9526 | 27 | 0.15 Nb 0.1 Ta | 10 h 850° C. | 2.120 | 2.225 | 2.276 | 2.373 | 2782 | 1.376 | 0.1337 |
| 9526 | 27 | 0.15 Nb 0.1 Ta | non-ann. | | | | | | 5.582 | |
| 9527 | 27 | 0.15 Nb 0.01 C | 10 h 850° C. | 2.127 | 2.230 | 2.281 | 2.373 | 2255 | 1.797 | 0.1335 |
| 9527 | 27 | 0.15 Nb 0.01 C | non-ann. | | | | | | 4.890 | |
| 9528 | 27 | 0.15 Nb 0.05 C | 10 h 850° C. | 2.139 | 2.244 | 2.295 | 2.389 | 1601 | 2.364 | 0.1271 |
| 9528 | 27 | 0.15 Nb 0.05 C | non-ann. | | | | | | 5.998 | |
| 9529 | 27 | 0.15 Nb 0.1 C | 10 h 850° C. | 2.110 | 2.219 | 2.271 | 2.370 | 1661 | 1.779 | 0.1277 |
| 9529 | 27 | 0.15 Nb 0.1 C | non-ann. | | | | | | 6.936 | |
| 9530 | 27 | 0.15 Nb 1 Cr | 10 h 850° C. | 2.111 | 2.213 | 2.261 | 2.334 | 2722 | 1.437 | 0.2731 |
| 9530 | 27 | 0.15 Nb 1 Cr | non-ann. | | | | | | 5.760 | |
| 9531 | 27 | 0.15 Nb 0.1 Mn 0.1 Si | 10 h 850° C. | 2.126 | 2.232 | 2.283 | 2.381 | 2822 | 1.475 | 0.1519 |
| 9531 | 27 | 0.15 Nb 0.1 Mn 0.1 Si | non-ann. | | | | | | 4.220 | |
| 9697 | 22 | — | 10 h 850° C. | 2.075 | 2.176 | 2.227 | 2.348 | 2319 | 1.455 | 0.1626 |
| 9698 | 30 | — | 10 h 850° C. | 2.188 | 2.295 | 2.340 | 2.401 | 1343 | 4.180 | 0.1030 |
| 9699 | 22 | 0.15 Nb | 10 h 850° C. | 2.072 | 2.173 | 2.224 | 2.349 | 3612 | 1.050 | 0.1709 |
| 9700 | 30 | 0.15 Nb | 10 h 850° C. | 2.173 | 2.283 | 2.333 | 2.402 | 2438 | 1.280 | 0.1134 |
| 9282 | 27 | 0.15 Nb | 10 h 850° C. | 2.125 | 2.229 | 2.281 | 2.384 | 2257 | 1.106 | 0.1382 |

Polarisation: J100 = J(100 A/cm), J160 = J(160 A/cm), J200 = J(200 A/cm), J400 = J(400 A/cm); Values in T
Maximum permeability: μmax (non-dimensional); Coercitive field strength: H_{C} in A/cm; Specific electric resistance rho = ρₑₗ in 10⁻⁶ Ωm

TABLE 3
Chemical Analysis

| Batch | Co | additions | Co | Nb | V | Cr | Mn | Ni | Si | C |
|---|---|---|---|---|---|---|---|---|---|---|
| 9273 | 20 | — | 19.50 | <0.01 | <0.01 | <0.01 | <0.01 | <0.01 | 0.090 | <0.003 |
| 9274 | 27 | — | 26.70 | <0.01 | <0.01 | <0.01 | <0.01 | <0.01 | 0.070 | <0.003 |
| 9275 | 30 | — | 29.80 | <0.01 | <0.01 | <0.01 | <0.01 | <0.01 | 0.060 | <0.003 |
| 9276 | 35 | — | 35.10 | <0.01 | <0.01 | <0.01 | <0.01 | <0.01 | 0.040 | <0.003 |
| 9277 | 42 | — | 42.50 | <0.01 | <0.01 | <0.01 | <0.01 | 0.010 | 0.010 | <0.003 |
| 9278 | 27 | 0.6 Cr 0.01 C 0.6 Ni 0.25 Mn 0.25 Si | 26.80 | <0.01 | <0.01 | 0.590 | 0.230 | 0.600 | 0.290 | 0.0090 |
| 9279 | 27 | 0.6 Cr 0.23 C 0.6 Ni 0.25 Mn 0.25 Si | 26.60 | <0.01 | <0.01 | 0.600 | 0.260 | 0.600 | 0.300 | 0.2570 |
| 9280 | 27 | 2 Cr | 27.00 | <0.01 | <0.01 | 1.950 | <0.01 | <0.01 | 0.070 | <0.003 |
| 9281 | 27 | 1 Ni | 26.75 | <0.01 | <0.01 | <0.01 | <0.01 | 1.000 | <0.07 | <0.003 |
| 9282 | 27 | 0.15 Nb | 26.20 | 0.150 | <0.01 | <0.01 | <0.01 | 0.010 | 0.070 | 0.0040 |
| 9522 | 27 | 0.1 Nb | 27.02 | 0.090 | <0.01 | <0.01 | <0.01 | <0.01 | <0.01 | 0.0009 |
| 9523 | 27 | 0.3 Nb | 26.90 | 0.260 | <0.01 | <0.01 | <0.01 | <0.01 | <0.01 | 0.0011 |
| 9524 | 27 | 0.4 Nb | 26.90 | 0.350 | <0.01 | <0.01 | <0.01 | <0.01 | <0.01 | 0.0011 |
| 9525 | 27 | 0.4 Ta | 26.96 | 0.040 | <0.01 | <0.01 | <0.01 | <0.01 | <0.01 | 0.0015 |
| 9526 | 27 | 0.15 Nb 0.1 Ta | 26.85 | 0.150 | <0.01 | <0.01 | <0.01 | <0.01 | <0.01 | 0.0015 |
| 9527 | 27 | 0.15 Nb 0.01 C | 26.90 | 0.140 | <0.01 | <0.01 | <0.01 | <0.01 | <0.01 | 0.0051 |
| 9528 | 27 | 0.15 Nb 0.05 C | 26.85 | 0.150 | <0.01 | <0.01 | <0.01 | <0.01 | <0.01 | 0.0460 |
| 9529 | 27 | 0.15 Nb 0.1 C | 26.93 | 0.170 | <0.01 | <0.01 | <0.01 | <0.01 | <0.01 | 0.1150 |
| 9530 | 27 | 0.15 Nb 1 Cr | 27.15 | 0.140 | <0.01 | 0.990 | <0.01 | <0.01 | <0.01 | 0.0010 |
| 9531 | 27 | 0.15 Nb 0.1 Mn 0.1 Si | 26.90 | 0.170 | <0.01 | <0.01 | 0.100 | <0.01 | 0.060 | 0.0008 |
| 9532 | 27 | 0.15 Nb 0.1 Mn 0.1 Si | 26.85 | 0.150 | <0.01 | <0.01 | 0.110 | <0.01 | 0.070 | 0.0011 |
| 9697 | 22 | — | 21.80 | <0.01 | <0.01 | <0.01 | <0.01 | <0.01 | <0.01 | 0.0010 |
| 9698 | 30 | — | 30.20 | <0.01 | <0.01 | <0.01 | <0.01 | <0.01 | <0.01 | 0.0008 |
| 9699 | 22 | 0.15 Nb | 27.70 | 0.130 | <0.01 | <0.01 | <0.01 | <0.01 | <0.01 | 0.0009 |
| 9700 | 30 | 0.15 Nb | 30.25 | 0.150 | <0.01 | <0.01 | <0.01 | <0.01 | <0.01 | 0.0008 |
| Batch | S | O | N | Al | Mo | Cu | Ta | Ce | Zr | Ti |
| 9273 | 0.0040 | 0.0270 | 0.0017 | <0.01 | <0.01 | <0.01 | — | — | — | — |
| 9274 | 0.0040 | 0.0250 | 0.0011 | <0.01 | <0.01 | <0.01 | — | — | — | — |
| 9275 | 0.0040 | — | 0.0013 | <0.01 | <0.01 | <0.01 | — | — | — | — |
| 9276 | 0.0030 | 0.0220 | 0.0014 | <0.01 | <0.01 | <0.01 | — | — | — | — |
| 9277 | 0.0040 | 0.0190 | 0.0014 | <0.01 | <0.01 | <0.01 | — | — | — | — |
| 9278 | 0.0040 | 0.0024 | 0.0010 | <0.01 | <0.01 | <0.01 | — | — | — | — |
| 9279 | 0.0040 | 0.0025 | 0.0014 | <0.01 | <0.01 | <0.01 | — | — | — | — |
| 9280 | 0.0040 | — | 0.0011 | <0.01 | <0.01 | <0.01 | — | — | — | — |
| 9281 | 0.0040 | 0.0200 | 0.0110 | <0.01 | <0.01 | <0.01 | — | — | — | — |
| 9282 | 0.0040 | 0.0100 | 0.0015 | <0.01 | <0.01 | <0.01 | — | — | — | — |
| 9522 | 0.0025 | 0.0110 | 0.0020 | <0.01 | <0.01 | <0.01 | 0.004 | <0.01 | <0.01 | <0.01 |
| 9523 | 0.0025 | 0.0090 | 0.0020 | <0.01 | <0.01 | <0.01 | 0.010 | <0.01 | <0.01 | <0.01 |
| 9524 | 0.0026 | 0.0080 | 0.0020 | <0.01 | <0.01 | <0.01 | 0.010 | <0.01 | <0.01 | <0.01 |
| 9525 | 0.0025 | 0.0040 | 0.0020 | <0.01 | <0.01 | <0.01 | 0.210 | <0.01 | <0.01 | <0.01 |
| 9526 | 0.0025 | 0.0070 | 0.0020 | <0.01 | <0.01 | <0.01 | 0.050 | <0.01 | <0.01 | <0.01 |
| 9527 | 0.0023 | 0.0100 | 0.0020 | <0.01 | <0.01 | <0.01 | 0.020 | <0.01 | <0.01 | <0.01 |
| 9528 | 0.0023 | 0.0040 | 0.0020 | <0.01 | <0.01 | <0.01 | 0.020 | <0.01 | <0.01 | <0.01 |
| 9529 | 0.0023 | 0.0030 | 0.0020 | <0.01 | <0.01 | <0.01 | 0.020 | <0.01 | <0.01 | <0.01 |
| 9530 | 0.0025 | 0.0090 | 0.0010 | <0.01 | <0.01 | <0.01 | 0.010 | <0.01 | <0.01 | <0.01 |
| 9531 | 0.0024 | 0.0040 | 0.0020 | <0.01 | <0.01 | <0.01 | 0.030 | <0.01 | <0.01 | <0.01 |
| 9532 | 0.0024 | 0.0050 | 0.0030 | <0.01 | <0.01 | <0.01 | 0.020 | <0.01 | <0.01 | <0.01 |
| 9697 | 0.0019 | 0.0220 | 0.0011 | <0.01 | <0.01 | <0.01 | — | — | — | <0.01 |
| 9698 | 0.0018 | 0.0210 | 0.0013 | <0.01 | <0.01 | <0.01 | — | — | — | <0.01 |
| 9699 | 0.0016 | 0.0150 | 0.0015 | <0.01 | <0.01 | <0.01 | — | — | — | <0.01 |
| 9700 | 0.0012 | 0.0130 | 0.0015 | <0.01 | <0.01 | <0.01 | — | — | — | <0.01 |

Remainder Fe
Values in % by weight

TABLE 4
Mechanical Properties

| Batch | Co | Additions | State | Annealed | E-Module in GPa | Rp_{0.2} in MPa | Rm in MPa | A_{L} in % | HV10 |
|---|---|---|---|---|---|---|---|---|---|
| 9274 | 27 | none | hot-rolled | 10 h 850° C. | 222 | 291 | 338 | 1.20 | 162 |
| 9274 | 27 | none | hot-rolled | non-ann. | 225 | 345 | 450 | 2.50 | 181 |
| 9278 | 27 | 0.6 Cr 0.01 C 0.6 Ni | hot-rolled | 10 h 850° C. | 216 | 310 | 586 | 10.30 | 182 |
| | | 0.25 Mn 0.25 Si | | | | | | | |
| 9278 | 27 | 0.6 Cr 0.01 C 0.6 Ni | hot-rolled | non-ann. | 210 | 500 | 649 | 24.30 | 221 |
| | | 0.25 Mn 0.25 Si | | | | | | | |
| 9279 | 27 | 0.6 Cr 0.23 C 0.6 Ni | hot-rolled | 10 h 850° C. | 222 | 456 | 629 | 2.80 | 244 |
| | | 0.25 Mn 0.25 Si | | | | | | | |
| 9279 | 27 | 0.6 Cr 0.23 C 0.6 Ni | hot-rolled | non-ann. | 235 | 623 | 902 | 18.40 | 283 |
| | | 0.25 Mn 0.25 Si | | | | | | | |
| 9280 | 27 | 2 Cr | hot-rolled | 10 h 850° C. | 218 | 286 | 567 | 31.80 | 175 |
| 9280 | 27 | 2 Cr | hot-rolled | non-ann. | 229 | 387 | 572 | 18.80 | 198 |
| 9281 | 27 | 1 Ni | hot-rolled | 10 h 850° C. | 223 | — | 289 | 0.00 | 196 |
| 9281 | 27 | 1 Ni | hot-rolled | non-ann. | 219 | 391 | 556 | 5.20 | 192 |

TABLE 5
Magnetic Properties

| Batch | Co | Additions | State | Annealed | J100 | J160 | J200 | J400 | μmax | H_{C} in A/cm | rho |
|---|---|---|---|---|---|---|---|---|---|---|---|
| 9274 | 27 | none | hot-rolled | 10 h 850° C. | 2.138 | 2.244 | 2.294 | 2.389 | 1483 | 3.640 | 0.1279 |
| 9278 | 27 | 0.6 Cr 0.01 C 0.6 Ni | hot-rolled | 10 h 850° C. | 2.115 | 2.222 | 2.271 | 2.341 | 2292 | 1.320 | 0.2493 |
| | | 0.25 Mn 0.25 Si | | | | | | | | | |
| 9279 | 27 | 0.6 Cr 0.23 C 0.6 Ni | hot-rolled | 10 h 850° C. | 2.015 | 2.116 | 2.158 | 2.233 | 251 | 8.100 | 0.1952 |
| | | 0.25 Mn 0.25 Si | | | | | | | | | |
| 9280 | 27 | 2 Cr | hot-rolled | 10 h 850° C. | 2.095 | 2.202 | 2.247 | 2.299 | 2759 | 1.281 | 0.3862 |
| 9281 | 27 | 1 Ni | hot-rolled | 10 h 850° C. | 2.146 | 2.256 | 2.307 | 2.389 | 1567 | 3.080 | 0.1285 |

Polarisation: J100 = J(100 A/cm), J160 = J(160 A/cm), J200 = J(200 A/cm), J400 = J(400 A/cm); Values in Tesla
Maximum permeability: μmax (non-dimensional); Coercitive field strength: H_{C} in A/cm; Specific electric resistance rho⁻⁶ = ρₑₗ in 10 Ωm

TABLE 6
Chemical Analysis

| Batch | Co | Additions | Co | Nb | V | Cr | Mn | Ni |
|---|---|---|---|---|---|---|---|---|
| 9274 | 27 | — | 26.70 | <0.01 | <0.01 | <0.01 | <0.01 | <0.01 |
| 9278 | 27 | 0.6 Cr 0.01 C 0.6 Ni | 26.80 | <0.01 | <0.01 | 0.590 | 0.230 | 0.600 |
| | | 0.25 Mn 0.25 Si | | | | | | |
| 9279 | 27 | 0.6 Cr 0.23C 0.6 Ni | 26.60 | <0.01 | <0.01 | 0.600 | 0.260 | 0.600 |
| | | 0.25 Mn 0.25 Si | | | | | | |
| 9280 | 27 | 2 Cr | 27.00 | <0.01 | <0.01 | 1.950 | <0.01 | <0.01 |
| 9281 | 27 | 1 Ni | 27.00 | <0.01 | <0.01 | <0.01 | <0.01 | 1.000 |
| Batch | Si | C | S | O | N | Al | Mo | Cu |
| 9274 | 0.070 | <0.003 | 0.0040 | 0.025 | 0.0011 | <0.01 | <0.01 | <0.01 |
| 9278 | 0.290 | 0.009 | 0.0040 | 0.002 | 0.001 | <0.01 | <0.01 | <0.01 |
| 9279 | 0.300 | 0.257 | 0.0040 | 0.003 | 0.0014 | <0.01 | <0.01 | <0.01 |
| 9280 | 0.070 | <0.003 | 0.0040 | — | 0.0011 | <0.01 | <0.01 | <0.01 |
| 9281 | <0.07 | <0.003 | 0.0040 | 0.020 | 0.011 | <0.01 | <0.01 | <0.01 |

Remainder Fe
Values in % by weight

1. Soft magnetic alloy, consisting essentially of
20% by weight≦Co≦30% by weight,
0% by weight≦Cr≦0.25% by weight,
0.06% by weight≦(2*Nb+Ta)≦0.8% by weight,
0.01% by weight≦Mn≦0.5% by weight,
0% by weight≦Si≦0.5% by weight,
0% by weight≦Ca≦0.01% by weight,
0% by weight≦Mg≦0.01% by weight,
0% by weight≦Ce≦0.01% by weight,
0% by weight≦Ni≦1.0% by weight, 0% by weight≦Al≦1.0% by weight,
0% by weight≦V≦1.0% by weight, 0% by weight≦Mo≦1.0% by weight,
0% by weight≦Zr≦0.1% by weight, 0% by weight≦Ti≦0.1% by weight,
0% by weight≦Cu≦0.1% by weight, 0% by weight≦W≦0.1% by weight,
0% by weight≦S≦0.01% by weight, 0% by weight≦O≦0.02% by weight,
0% by weight≦N≦0.01% by weight, 0% by weight≦C≦0.01% by weight,
0% by weight≦P≦0.01% by weight, 0% by weight≦B≦0.01% by weight,
remainder iron.

2. Soft magnetic alloy according to claim 1, wherein
0.150% by weight≦(2*Nb+Ta)≦0.350% by weight.

3. Soft magnetic alloy according to claim 2, wherein
0.250% by weight≦(2*Nb+Ta)≦0.350% by weight.

4. Soft magnetic alloy according to claim 3, wherein
0.280% by weight≦(2*Nb+Ta)≦0.320% by weight.

5. Soft magnetic alloy according to claim 1, wherein
0.10% by weight≦Nb≦0.20% by weight and 0% by weight≦Ta≦0.02% by weight.

6. Soft magnetic alloy according to claim 5, wherein
0.130% by weight≦Nb≦0.170% by weight and 0% by weight≦Ta≦0.02% by weight.

8. Soft magnetic alloy according to claim 1, wherein 0.01% by weight≦Si≦0.50% by weight.

9. Soft magnetic alloy according to claim 1, wherein 0.01% by weight≦Mn≦0.2% by weight.

10. Soft magnetic alloy according to claim 1, wherein
0.01% by weight≦Mn≦0.2% by weight and 0.01% by weight≦Si≦0.2% by weight.

11. Soft magnetic alloy according to claim 1, wherein 0.04% by weight≦Mn≦0.12% by weight and 0.04% by weight≦Si≦0.12% by weight.

12. Soft magnetic alloy according to claim 1, wherein
26.4% by weight≦Co≦27.6% by weight, 0.120% by weight≦Nb≦0.18% by weight and Ta=0% by weight, 0.04% by weight≦Mn≦0.12% by weight, and 0.04% by weight≦Si≦0.12% by weight.

13. Soft magnetic alloy according to claim 1, wherein
20% by weight≦Co≦28% by weight.

14. Soft magnetic alloy according to claim 13, wherein
25% by weight≦Co≦28% by weight.

15. Soft magnetic alloy according to claim 1 , wherein
0% by weight≦Cr≦0.2% by weight.

16. Soft magnetic alloy according to claim 15, wherein
0% by weight≦Cr≦0.02% by weight.

17. Soft magnetic alloy according claim 1, wherein
0% by weight≦Al≦0.2% by weight.

18. Soft magnetic alloy according to claim 17, wherein
0% by weight≦Al≦0.02% by weight.

19. Soft magnetic alloy according to claim 1, wherein the alloy has an elongation at fracture A_{L}≧25% in the hot-worked state and a polarisation J≧2.35 Tesla in the annealed state at room temperatures and under the application of a field strength of 400 A/cm.

20. Soft magnetic alloy according to claim 19, wherein the alloy has an elongation at fracture A_{L}≧30% in the hot-worked state and a polarisation J≧2.35 Tesla in the annealed state at room temperatures and under the application of a field strength of 400 A/cm.
